(19) United States
(12) Patent Application Publication
(10) Pub. No.: US 2021/0368952 A1
(43) Pub. Date: Dec. 2, 2021

(54) SMART LUGGAGE SYSTEM WITH ULTRA-WIDEBAND BASED TARGET TRACKING SYSTEM

(71) Applicant: LINGDONG TECHNOLOGY (BEIJING) CO. LTD, Beijing (CN)

(72) Inventors: Zhaoqiang CHEN, Beijing (CN); Congxiang WANG, Beijing (CN)

(21) Appl. No.: 16/325,358

(22) PCT Filed: Jan. 18, 2019
(86) PCT No.: PCT/CN2019/072330

§ 371 Date: Feb. 13, 2019

(51) Int. Cl. A45C 5/14; G05D 1/00; G05D 1/02; G06K 7/10

(52) U.S. Cl. CPC A45C 5/14; G05D 1/0016; G06K 7/10306; G05D 1/0238; G05D 1/0022

(57) ABSTRACT

A smart luggage system includes a piece of luggage configured to store items for transport and a handle coupled to the luggage. The smart luggage system includes an ultra-wideband based target tracking system that uses a combination of an angle of arrival mechanism and a time difference of arrival mechanism to help determine the position of a user relative to the luggage. The ultra-wideband based target tracking system helps maintain the luggage moving in a rear following position or a side following position relative to the user.

### BACKGROUND

### Field

Embodiments disclosed herein relate to a smart luggage system having an ultra-wideband based target tracking system.

### Description of the Related Art

Current self-driving luggage designs have cameras located on the body of the luggage that are used for proximity sensing to follow a user and avoid obstacles, especially when being used in crowded places like airports, hotels, or a busy sidewalk. The proximity sensing of the cameras is easily obstructed whenever there is a change in the surrounding environment's lighting conditions. Specifically, when there is a sharp change in the lighting condition, the camera will lose sight of a light or laser from a corresponding laser emitter that is reflected off of the user to help determine the user's proximity to the luggage. When the camera loses sight of the light or laser from the laser emitter, the luggage will stop following the user, which will require the user to have to stop and reestablish connection with the luggage to continue moving. Therefore there is a continuous need for new and improved smart luggage systems with target tracking.

### SUMMARY

In one embodiment, a smart luggage system comprises a piece of luggage configured to store items for transport; an ultra-wideband (UWB) based tracking system configured to determine the position of a target relative to the luggage and comprising an onboard UWB device coupled to the luggage, wherein the onboard UWB device comprises three transceivers, a crystal oscillator, and a control module; and a wheel control system configured to move the luggage in a given direction based on information from the UWB based tracking system, wherein the wheel control system comprises a plurality of motorized wheel assemblies coupled to the luggage.

In one embodiment, a smart luggage system comprises a piece of luggage configured to store items for transport; an ultra-wideband (UWB) based tracking system configured to determine the position of a target relative to the luggage and comprising an onboard UWB device coupled to the luggage, wherein the onboard UWB device comprises three transceivers, a crystal oscillator, and a control module; an obstacle avoidance system configured to determine the position of an obstacle relative to the luggage and comprising a camera for environment recognition, a camera having an optical filter, a laser emitter, and a proximity sensor each coupled to the luggage; and a wheel control system configured to move the luggage in a given direction based on information from the UWB based tracking system and the obstacle avoidance system, wherein the wheel control system comprises a plurality of motorized wheel assemblies coupled to the luggage.

In one embodiment, a method of tracking a target using a smart luggage system comprises receiving a signal from a mobile ultra-wideband (UWB) device of a personal user device of a target; determining a position of the target relative to a piece of luggage based on the signal using a UWB based tracking system having an onboard UWB device coupled to the luggage, wherein the onboard UWB device comprises three transceivers, a crystal oscillator, and a control module; determining a position of the target relative to the luggage using a computer based tracking system having a camera for target recognition, a camera having an optical filter, and a laser emitter each coupled to the luggage; and moving the luggage in a given direction based on the position of the target as determined by the UWB based tracking system and the computer based tracking system.

In one embodiment, a method of tracking a target using a smart luggage system comprises receiving a signal from a mobile ultra-wideband (UWB) device of a personal user device of a target; determining a position of the target relative to a piece of luggage based on the signal using a UWB based tracking system having an onboard UWB device coupled to the luggage, wherein the onboard UWB device comprises three transceivers, a crystal oscillator, and a control module; determining a position of an obstacle relative to the luggage using an obstacle avoidance system having a camera for environment recognition, a camera having an optical filter, a laser emitter, and a proximity sensor each coupled to the luggage; and moving the luggage in a given direction to avoid the obstacle based on the position of the target as determined by the UWB based tracking system and the position of the obstacle as determined by the obstacle avoidance system.

### BRIEF DESCRIPTION OF THE DRAWINGS

FIG. 1 is a schematic view of a smart luggage system following a user in a rear following position according to one embodiment.

FIG. 2 is a schematic view of a personal user device communicating with the smart luggage system according to one embodiment.

FIG. 3 is a schematic view of an angle of arrival calculation method according to one embodiment.

FIG. 4 is a schematic view of the personal user device communicating with the smart luggage system according to one embodiment.

FIG. 5 is a schematic view of a target tracking system of the smart luggage system according to one embodiment.

FIG. 6 is a schematic view of the smart luggage system according to one embodiment.

FIG. 7 is a schematic view of the smart luggage system according to one embodiment.

FIG. 8 is a block diagram of the smart luggage system according to one embodiment.

FIG. 9 is a schematic view of the smart luggage system according to one embodiment.

FIG. 10 is a schematic view of the smart luggage system according to one embodiment.

FIG. 11A is a schematic view of the smart luggage system according to one embodiment.

FIG. 11B is a schematic view of a frame of the smart luggage system according to one embodiment.

FIG. 11C is an enlarged view of a portion of the frame of the smart luggage system according to one embodiment.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

Embodiments of the disclosure include a smart luggage system that is self-driving and has one or more motorized wheel assemblies. The smart luggage system is configured to autonomously follow any type of target, such as a user, moving in a given direction. Although the embodiments of the smart luggage system are described and illustrated herein with respect to a suitcase, the embodiments may be used with other types of portable equipment, such as a shopping cart.

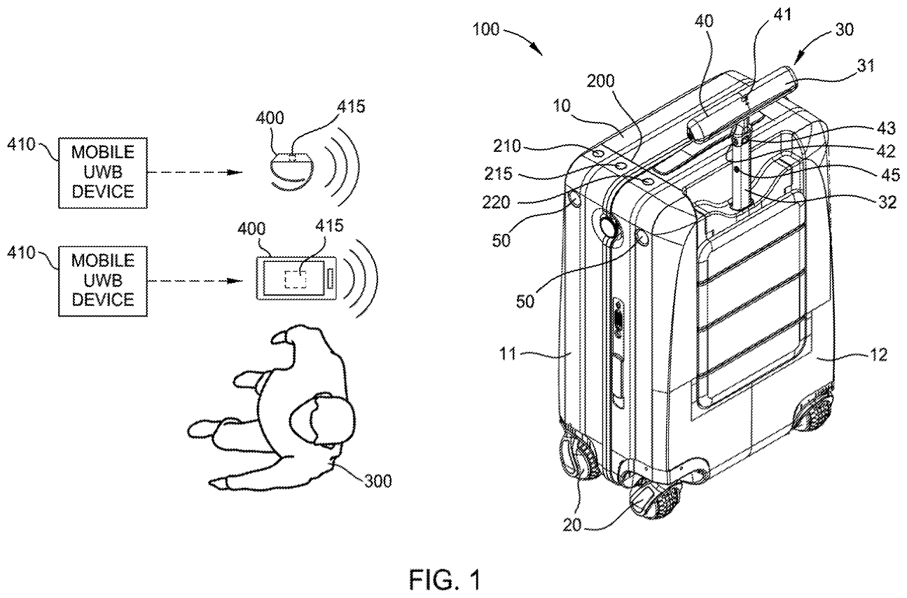

FIG. 1 is a schematic view of a smart luggage system 100 following a user 300 in a rear following position according to one embodiment. The smart luggage system 100 includes a body in the form of a piece of luggage 10, such as a suitcase, that can be used to store items for transport. When in the rear following position, the smart luggage system 100 is autonomously following the user 300 from behind. The smart luggage system 100 can also follow the user 300 in a side following positon. When in the side following position, the smart luggage system 100 is autonomously following the user 300 on a right side or a left side of the user 300.

The smart luggage system 100 further includes four wheel assemblies 20 coupled to a bottom of the luggage 10. Each wheel assembly 20 is configured to rotate in a given direction and roll in the given direction. Each wheel assembly 20 is motorized to move the luggage 10 in a given direction. In one embodiment, the luggage 10 is supported by two, three, or more wheel assemblies 20. In one embodiment, a plurality (e.g. two, three, or more) of the wheel assemblies 20 are motorized to move the luggage in a given direction. In one embodiment, the wheel assemblies 20 are caster-type wheels.

The smart luggage system 100 further includes one or more proximity sensors 50 coupled to the luggage 10. Two proximity sensors 50 are shown coupled to a front side 11 of the luggage 10 near the top end of the luggage 10. Any number of proximity sensors 50 can be used and located at different positions and/or on any side of the luggage 10. The proximity sensors 50 are configured to detect the proximity (e.g. distance) of one or more targets, such as the user 300, relative to the luggage 10 to help determine the position of the target relative to the luggage 10. The proximity sensors 50 include but are not limited to ultrasonic sensors, sonar sensors, infrared sensors, radar sensors, and/or LiDAR sensors.

The smart luggage system 100 further includes a handle 30 coupled to the luggage 10. The handle 30 is configured to allow the user 300 to push, pull, and/or lift the luggage 10. The handle 30 is located on a right side 12 of the luggage 10, but alternatively can be located on the opposite side. The handle 30 includes a pull rod 31 coupled to a connecting rod 32, which is coupled to the luggage 10. The pull rod 31 forms a “T” shape.

One or more upper cameras 40, 41 are coupled to the top portion of the pull rod 31. One or more lower cameras 42, 43 are coupled to the bottom portion of the pull rod 31. A laser emitter 45 is coupled to the bottom portion of the pull rod 31. The top portion of the pull rod 31 is an elongated portion that is oriented horizontally and is perpendicular to the bottom portion. The bottom portion of the pull rod 31 is oriented vertically and is perpendicular to the top portion.

The upper camera 40, the lower camera 42, and the laser emitter 45 are facing forward toward the front side 11 of the luggage. The upper camera 41 and the lower camera 43 are facing sideways toward the right side 12 of the luggage 10. The same or another laser emitter 45 can be coupled to the handle 30 facing sideways toward the right side 12 of the luggage 10. Additionally or alternatively, the upper cameras 40, 41, the lower cameras 42, 43, and/or the laser emitter 45 can be positioned on the opposite sides of the handle 30 such that they are facing rear toward the rear side of the luggage and/or facing sideways toward the left side of the luggage 10. Embodiments of the smart luggage system 100 include any combination, number, and/or location of upper and/or lower cameras 40-43 and/or laser emitters 45 coupled to the handle 30.

In one embodiment, the cameras 40-43 are configured to detect and record, such as take photographs and/or videos, of nearby targets. In one embodiment, the lower cameras 42, 43 are configured to detect the proximity (e.g. distance) of targets relative to the luggage 10 to help determine the position of the target relative to the luggage 10. For example, the lower cameras 42, 43 include an optical filter configured to identify invisible light/laser emitted from the laser emitter 45 and reflected off of the target to help calculate the proximity of nearby targets. In one embodiment, the upper cameras 40, 41 are configured to take photographs and/or videos (for target recognition as one example) of nearby targets, and the lower cameras 42, 43 are configured to detect the proximity of nearby targets (for proximity sensing as one example).

Ultra-Wideband Based Target Tracking System

The system 100 includes an onboard ultra-wideband (UWB) device 200 coupled to the luggage 10. The onboard UWB device 200 has a positioning component that includes three wireless transceivers 210, 215, 220 (such as antennas), which are configured to receive one or more signals (such as a radio frequency wave) from a personal user device 400 having a mobile ultra-wideband (UWB) device 410. The signal is communicated by a transmitter 415 of the mobile UWB device 400 to the transceivers 210, 215, 220 identify the position of a target, such as the user 300, relative to the luggage 10.

It is understood that the mobile UWB device 410 and the transmitter 415 are integrated into the personal user device 400. The mobile UWB device 410 and the transmitter 415 may be in the form of hardware disposed within the personal user device 400 and/or software programmed into the personal user device 400. The personal user device 400 is shown as a wristband and a cellular phone, but may also be a tablet, a computer, and/or any other device that can be configured with the mobile UWB device 410 and the transmitter 415 to communicate with the onboard UWB device 200.

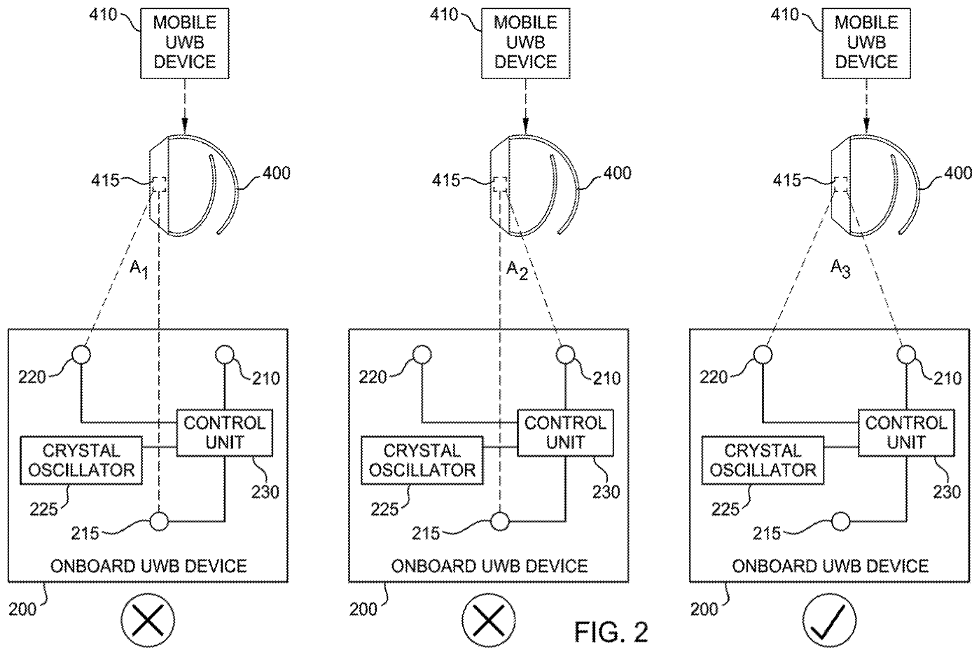

The combination of the onboard UWB device 200 and the mobile UWB device 410 forms a UWB based target tracking system configured to identify the position of the user 300 relative to the luggage 10 when the user 300 is wearing or is otherwise in possession of the personal user device 400. The target tracking system helps to keep the luggage 10 moving in the rear following position or the side following position relative to the user 300 regardless of any changes in the surrounding environment's lighting conditions as further described below with respect to FIGS. 2-6.

Ultra-wideband is a radio wave technology that uses low energy for short-range, high-bandwidth communications over a large portion of the radio spectrum, which includes frequencies within a range of 3 hertz to 3,000 gigahertz. The ultra-wideband based target tracking system of the smart luggage system 100 uses a combination of an angle of arrival mechanism and a time difference of arrival mechanism to help determine the position of the user 300 relative to the luggage 10.

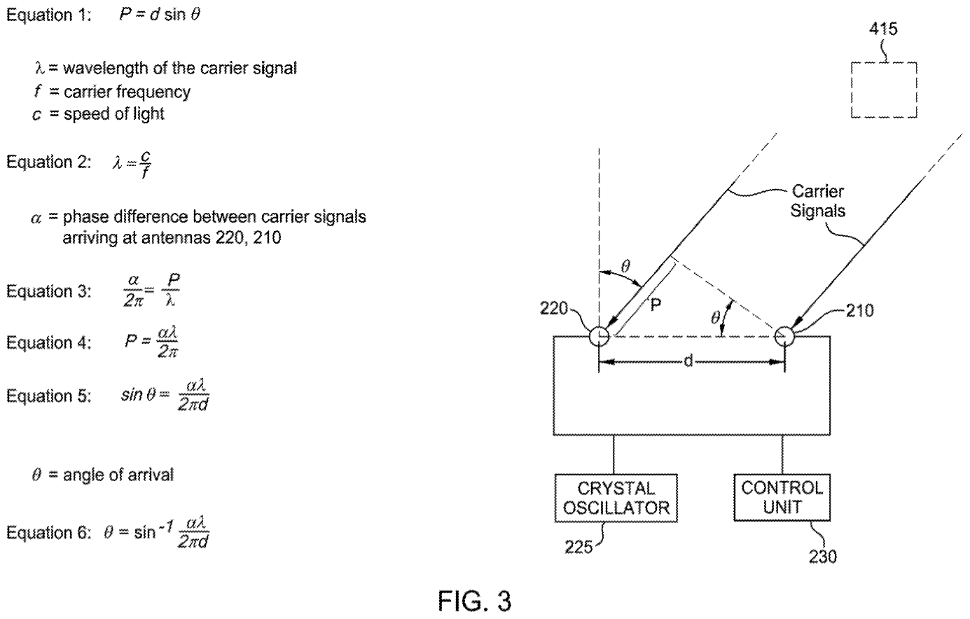

The angle of arrival mechanism is shown in FIGS. 2 and 3. The angle of arrival mechanism is a method for determining the largest angle between each pair of transceivers 210, 215, 220 relative to the transmitter 415 of the mobile UWB device 410, and then using that specific pair of transceivers to determine the position of the transmitter 415 relative to the onboard UWB device 200 on the luggage 10.

As shown in FIG. 2, the transmitter 415 of the mobile UWB device 410 on the personal user device 400 wirelessly communicates a signal (such as a radio frequency wave) to the transceivers 210, 215, 220 of the onboard UWB device 200. Presumably the user 300 is wearing or is otherwise in possession of the personal user device 400 and therefore the position of the user 300 is being calculated. Specifically, a control unit 230 (such as a central processing unit) and a crystal oscillator 225 of the onboard UWB device 200 are configured to continuously calculate the angle at which the transmitter 415 is located relative to two of the transceivers 210, 215, 220 to determine the largest angle.

Position angle 1 is the angle at which the transmitter 415 is located relative to transceivers 215, 220 as calculated by the control unit 230 in conjunction with the crystal oscillator 225. Position angle 2 is the angle at which the transmitter 415 is located relative to transceivers 210, 215 as calculated by the control unit 230 in conjunction with the crystal oscillator 225. Position angle 3 is the angle at which the transmitter 415 is located relative to transceivers 210, 220 as calculated by the control unit 230 in conjunction with the crystal oscillator 225. The control unit 230 includes an algorithm configured to calculate the position angles A1, A2, A3 based on an angle of arrival calculation method as shown in FIG. 3.

FIG. 3 shows one example of an angle of arrival calculation method for one pair of transceivers, specifically transceivers 210, 220, relative to the transmitter 415 of the mobile UWB device 410. As shown in FIG. 3, the transceivers 210, 220 receive one or more carrier signals (such as a radio frequency wave) from the transmitter 415. The crystal oscillator 225 provides clock information which helps define the wavelength of the carrier signal (λ) and the phase difference between the two carrier signals (α) arriving at the two transceivers 210, 220 (e.g. two antennas). Additionally or alternatively, the wavelength of the carrier signal (λ) can be calculated using equation (2) based on the known frequency (f) of the carrier signal and the speed of light (c). A distance (d) is known based on the positions of the transceivers 210, 220.

The angle of arrival (θ) of the carrier signals from the transmitter 415 to each pair of transceivers 210, 215, 220 can be calculated using equation (6) via the control unit 230. Various angles of arrivals between the transceivers 210, 215, 220 and the transmitter 415 of the mobile UWB device 410 of the personal user device 400 can be calculated using the above method. The various angles of arrival can then be used to calculate the position angles A1, A2, A3 as shown in FIG. 2. For example, the position angles A1, A2, A3 may be calculated by adding and/or subtracting one or more of the angles of arrival (and/or angles adjacent to the angles of arrival) of carrier signals relative to one or more of the transceivers 210, 215, 220. While one example of determining the angle of arrival of the carrier signals is described above, other methods of determining the angle of arrival as known in the art may be used.

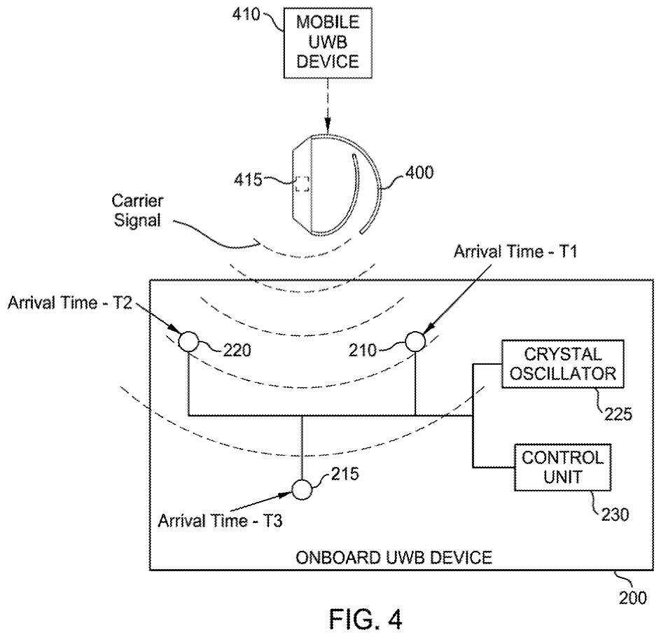

As shown in FIG. 2, since position angle A3 is greater than position angle A1 and position angle A2, then control unit 230 of the onboard UWB device 200 will use transceivers 210, 220 to calculate the proximity of the transmitter 415 relative to the luggage 10. However, the position angle A3 alone will not provide an indication from which side the transmitter 415 is located. Although the transmitter 415 is shown on one side of the onboard UWB device 200, it is possible that the same position angle A3 can be calculated with the transmitter 415 being located on the opposite side of the onboard UWB device 200. The onboard UWB device 200 is therefore also configured to use the time difference of arrival mechanism as shown in FIG. 4 to determine on which side the transmitter 415 is located.

The time difference of arrival mechanism is shown in FIG. 4. The time difference of arrival mechanism is a method for determining the difference in the arrival time of one or more carrier signals (such as a radio frequency wave) from the transmitter 415 to each of the transceivers 210, 215, 220. The specific transceiver that first receives the signal is used to calculate which side the transmitter 415 is located on relative to the onboard UWB device 200.

Referring to FIG. 4, the transmitter 415 of the mobile UWB device 410 on the personal user device 400 wirelessly communicates one or more carrier signals (such as a radio frequency wave) with the transceivers 210, 215, 220 of the onboard UWB device 200. Presumably the user 300 is wearing or is otherwise in possession of the personal user device 400 and therefore the position of the user 300 is being identified. Specifically, the control unit 230 and the crystal oscillator 225 of the onboard UWB device 200 continuously calculate the position of the transmitter 415 based on the difference in arrival time that each transceiver 210, 215, 220 detects the carrier signal from the transmitter 415.

The crystal oscillator is an electronic oscillator circuit that uses the mechanical resonance of a vibrating crystal of piezoelectric material to create an electrical signal. The electric signal has a frequency that is used to keep track of time to provide a stable clock signal. The transceivers 210, 215, 220 share the same crystal oscillator 225 so that they each have the exact same stable clock signal. In this manner, the transceivers 210, 215, 220 can be used to determine from which side the transmitter 415 is located by calculating the time difference of arrival based on the arrival time of the signal from the transmitter 415 as detected by each one transceiver 210, 215, 220 relative to each one other transceiver 210, 215, 220.

As shown in FIG. 4, based on the location of the transmitter 415 relative to the transceivers 210, 215, 220, the signal from the transmitter 415 has an arrival time T1 as detected by the transceiver 210, an arrival time T2 as detected by the transceiver 220, and an arrival time T3 as detected by the transceiver 215. Based on the arrival times T1, T2, T3 as detected by the transceivers 210, 215, 220 and the crystal oscillator 225 and calculated by the control unit 230, the control unit 230 is then configured to determine which side the transmitter 415 is located relative to the onboard UWB device 200.

Based on the proximity of the transmitter 415 as continuously calculated by the onboard UWB device 200 using the angle of arrival mechanism, and based on the location of the transmitter 415 (e.g. which side the transmitter 415 is located on relative to the luggage 10) as continuously calculated by the onboard UWB device 200 using the time difference of arrival mechanism, the smart luggage system 100 is configured to determine the position of the luggage 10 relative to the user 300. The smart luggage system 100 can continuously maintain the luggage 10 in a rear following position or a side following position relative to the user 300 as long as the user 300 wears or is in possession of the personal user device 400 which contains the mobile UWB device 410. The UWB based target tracking system of the smart luggage system 100 helps to keep the luggage 10 moving in the rear following position or the side following position relative to the user 300 regardless of any changes in the surrounding environments lighting conditions.

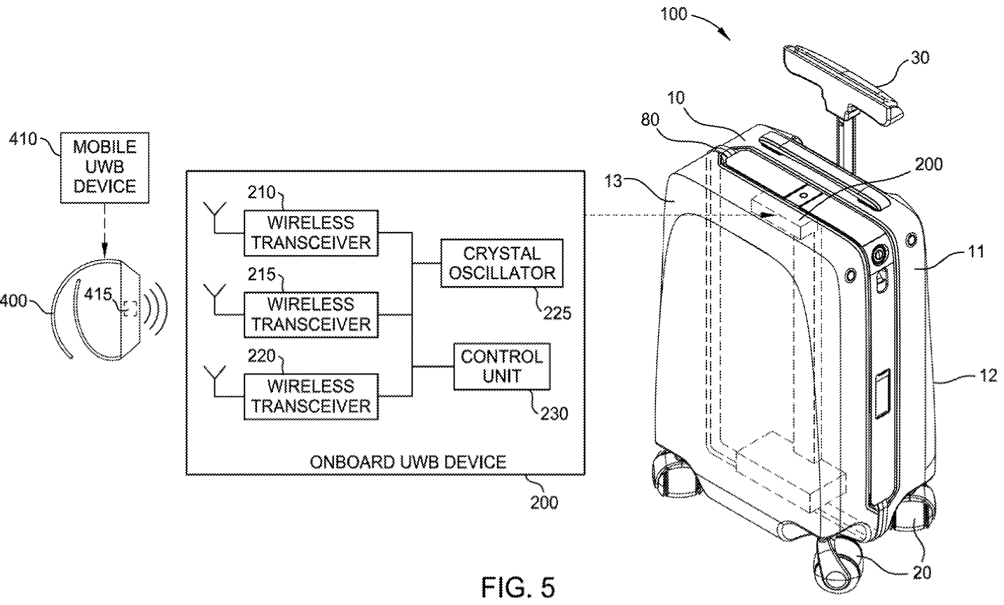

FIG. 5 illustrates the location of the onboard UWB device 200 relative to the luggage 10 of the smart luggage system 100. As shown, the onboard UWB device 200 is located inside and on a top end of the luggage 10 to be able to continuously communicate with the transmitter 415 of the mobile UWB device 410 in the personal user device 400 at all times. The onboard UWB device 200 is located on the top end and closer toward the left side 13 of the luggage 10 (e.g. the side opposite from the handle 30) adjacent to an aluminum frame 80 that forms part of the structural support of the luggage 10. The UWB device 200 may be secured within a plastic housing that is coupled to the inside of the luggage 10 at the top end on the left side 13. Alternatively, the onboard UWB device 200 can be located anywhere on the right side 12 or the left side 13 of the luggage 10. Alternatively, the onboard UWB device 200 can be located on the front side 11 (or the rear side) of the luggage 10. Alternatively, the onboard UWB device 200 can be located on the bottom end of the luggage 10.

UWB and Computer Vision Based Target Tracking Systems

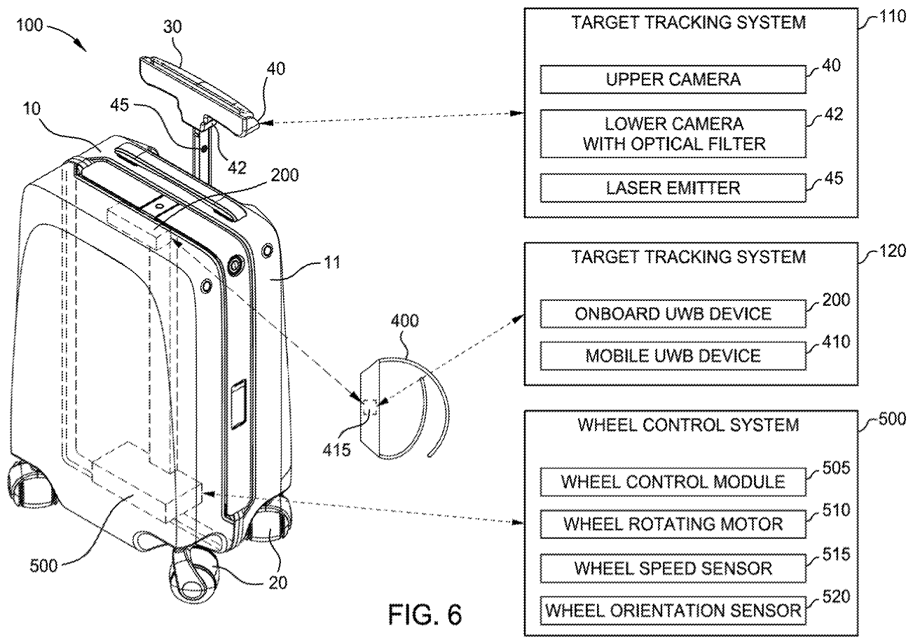

FIG. 6 is a schematic view of the smart luggage system 100 having a computer vision based target tracking system 110, a UWB based target tracking system 120, and a wheel control system 500.

The computer vision based target tracking system 110 comprises the combination of the upper camera 40, the lower camera 42 having an optical filter, and a laser emitter 45, each located in the handle 30 of the luggage 10. The computer vision based target tracking system 110 is configured to track a target, such as the user, using the recognition and detection by the upper camera 40, the lower camera 42 having the optical filter, and the laser emitter 45. The upper camera 40 is configured for target recognition to identify the target to follow. The lower camera 42 having the optical filter and the laser emitter 45 are configured for proximity sensing to determine the proximity of the target relative to the luggage. The light/laser emitted by the laser emitter 45 is reflected off of the target and detected by the lower camera 42 having the optical filter to determine the proximity of the target relative to the luggage 10. The target recognition and the proximity of the target are used to determine the position of the target relative to the luggage 10. When the position of the target relative to the luggage is determined, then the smart luggage system 100 will track and follow the target in a rear following position or a side following position based on the information received from the computer vision based target tracking system 110.

The UWB based target tracking system 120 comprises the onboard UWB device 200 and the mobile UWB device 410, including the transmitter 415 and the personal user device 400. The UWB based target tracking system 120 is configured to track a target, such as the user, using the combination of the angle of arrival mechanism and the time difference of arrival mechanism as described above with respect to FIGS. 1-5. The UWB based target tracking system 120 is configured for both target recognition and proximity sensing. The target recognition and the proximity of the target are used to determine the position of the target relative to the luggage 10. When the position of the target relative to the luggage is determined, then the smart luggage system 100 will track and follow the target in a rear following position or a side following position based on the information received from the UWB based target tracking system 120.

The computer vision based target tracking system 110 and the UWB based target tracking system 120 are each configured to communicate with the wheel control system 500 to keep the luggage 10 continuously moving in the rear following position or the side following position as the user moves in a given direction. The wheel control system 500 includes the wheel assemblies 20, a wheel control module 505, a wheel rotating motor 510, a wheel speed sensor 515, and a wheel orientation sensor 520 configured to move the wheel assemblies 20 at a speed and direction to maintain the luggage 10 in the rear following position or the side following position relative to the user. Specifically, the target tracking systems 110, 120 each determine the position of the user relative to the luggage 10, and communicate the position of the user to the wheel control system 500, which in response moves the luggage 10 in the rear following position or the side following position as the user moves in a given direction. The wheel control system 500 is shown coupled to the bottom end of the luggage 10 adjacent the wheel assemblies 20 but can be positioned at any other locations on the luggage 10.

UWB Based Target Tracking System and Obstacle Avoidance

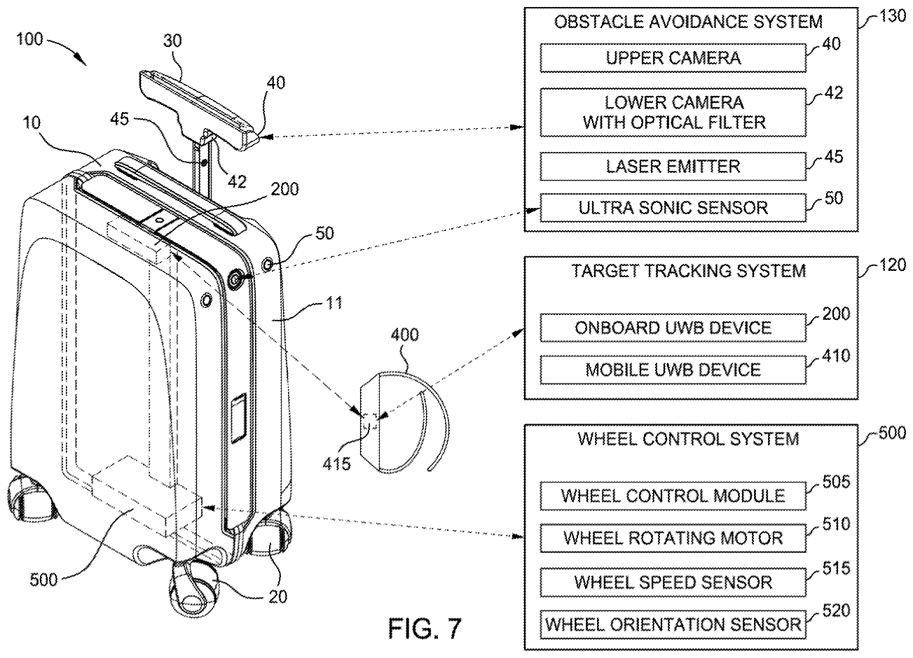

FIG. 7 is a schematic view of the smart luggage system 100 having an obstacle avoidance system 130, the UWB based target tracking system 120, and the wheel control system 500.

The obstacle avoidance system 120 comprises the combination of the upper camera 40, the lower camera 42 having an optical filter, the laser emitter 45, and the proximity sensor 50 (e.g. ultrasonic sensor). The obstacle avoidance system 130 is configured to determine the position of an obstacle relative to the luggage 10 as recognized and detected by the upper camera 40, the lower camera 42 having the optical filter, the laser emitter 45, and the proximity sensor 50. Obstacles may include other people or objects in the travel path of the luggage 10 when moving in a rear following position or a side following position relative to a user. The upper camera 40 is configured for environment recognition to identify the surrounding environment. The lower camera 42 having the optical filter, the laser emitter 45, and the proximity sensor 50 are configured for proximity sensing of obstacles. The environment recognition and the proximity sensing of obstacles are used to help the luggage 10 avoid obstacles when moving and following a target in a given direction. When an obstacle is identified, the smart luggage system 100 will take corrective action to move the luggage 10 and avoid a collision with the obstacle based on the information received from the obstacle avoidance system 130.

The obstacle avoidance system 130 and the UWB based target tracking system 120 are each configured to communicate with the wheel control system 500 to keep the luggage 10 continuously moving in the rear following position or the side following position as the user moves in a given direction. Specifically, the obstacle avoidance system 130 detects obstacles when the luggage 10 is moving and tracking a position of a target using the UWB target tracking system 120. Each system continuously communicates with the wheel control system 500 to move the luggage 10 to take any corrective action to avoid any obstacles and then transition back to the rear following position or the side following position once the obstacle is passed.

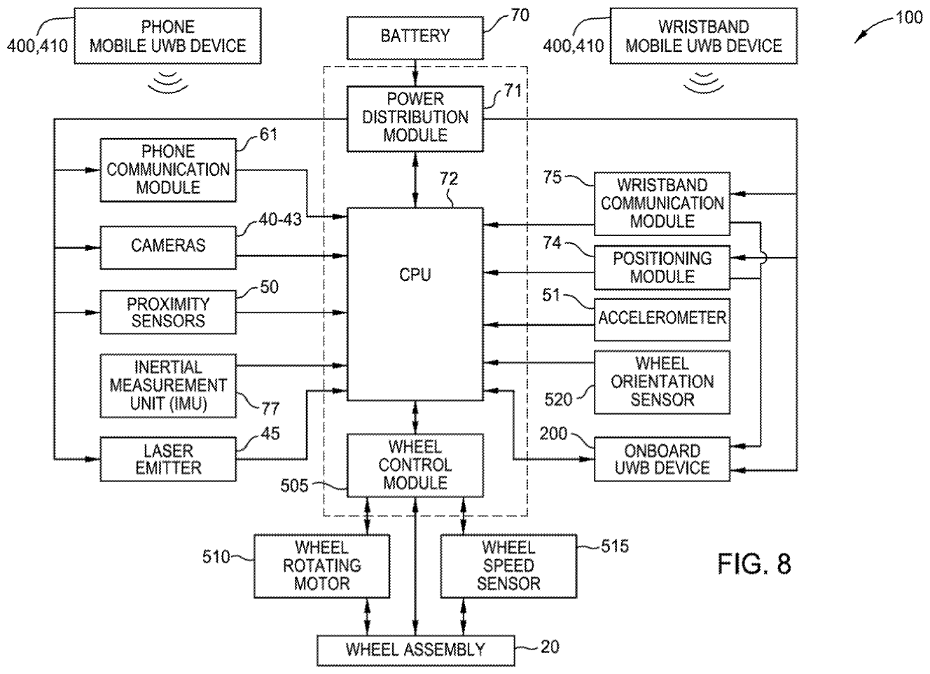

FIG. 8 is a block diagram of the smart luggage system 100 according to one embodiment. The smart luggage system 100 includes a battery 70 in communication with a power distribution module 71. The power distribution module 71 is configured to distribute power supplied by the battery 70 to the other components of the smart luggage system 100.

The smart luggage system 100 includes a central processing unit (“CPU”) 72 in communication with a phone communication module 61 and a wristband communication module 75. A cellular phone 400 with the mobile UWB device 410 and a wristband 400 with the mobile UWB device 410 are used to communicate with the phone communication module 61 and the wristband communication module 75, respectively, via ultra-wideband, radio frequency identification (active and/or passive), Bluetooth (low energy), WiFi, and/or any other form of communication known in the art. The cellular phone 400 with the mobile UWB device 410 and/or the wristband 400 with the mobile UWB device 410 are configured to allow the user to send a signal (such as instructions and/or a radio frequency wave) to the CPU 72 to control operation of the smart luggage system 100, and to receive information from the CPU 72 regarding the operation of the smart luggage system 100. The cellular phone 400 with the mobile UWB device 410 and/or the wristband 400 with the mobile UWB device 410 are also configured to allow the user to send a signal (such as instructions and/or a radio frequency wave) to the onboard UWB device 200 directly or through the CPU 72 to control operation of the smart luggage system 100, and to receive information from the with the onboard UWB device 200 directly or through the CPU 72 regarding the operation of the smart luggage system 100. The wristband communication module 75 may be a separate unit or integrated into the UWB device 200.

The CPU 72 is configured to receive information (such as the position of the user moving in a given direction) from the onboard UWB device 200, and in response instruct the wheel control system 500 to move the luggage 10 in the given direction. In one embodiment, the onboard UWB device 200 is configured to instruct the wheel control system 500 to move the luggage 10 in the given direction. In one embodiment, the CPU 72 is a separate processing unit than the control unit 230 of the onboard UWB device 200. In one embodiment, the CPU 72 and the control unit 230 are integrated into a single processing unit mounted on the onboard UWB device 200 or on the luggage 10 at a different location. In one embodiment, the power distribution module 71, the CPU 72, and the wheel control module 505 are integrated into a single processing unit (such as in the wheel control system 500 shown in FIGS. 6 and 7) coupled to the luggage 10.

A positioning module 74 is configured to communicate information regarding the position of the luggage 10 to the CPU 72, the onboard UWB device 200, and/or the user (via the cellular phone 400 and/or the wristband 400 for example). The positioning module 74 may be a separate unit or integrated into the UWB device 200. The positioning module 74 may include GPS (outdoor), WiFi access points (indoor), and/or Bluetooth beacons (indoor) so that the user can find the location of the smart luggage system 100 at any time, such as in the event that the smart luggage system 100 is lost. An accelerometer 51 is configured to communicate information regarding the overall acceleration and/or speed of the smart luggage system 100 to the CPU 72. A wheel orientation sensor 520 is configured to communicate information regarding the orientation of the motorized wheel assemblies 20 to the CPU 72.

The CPU 72 is also in communication with the upper and lower cameras 40-43, the proximity sensors 50, an inertial measurement unit (“IMU”) 77, and the wheel control module 505. The cameras 40-43 are configured to communicate information regarding the visual images and presence of nearby targets that the cameras 40-43 records and/or detects to the CPU 72. The proximity sensors 50 are configured to communicate information regarding the presence of targets near the smart luggage system 100 to the CPU 72. The IMU 77 is configured to communicate information regarding the dynamic movements of the smart luggage system 100, such as the pitch, roll, yaw, acceleration, and/or angular rate of the smart luggage system 100 to the CPU 72. For example, once the IMU 77 detects that the smart luggage system 100 is tilting or falling over, then the CPU 72 will instruct a wheel control module 505 to stop one or more wheel rotating motors 510 from rotating one or more of the wheel assemblies 20.

The wheel control module 505 is in communication with a wheel speed sensor 515 and the wheel rotating motor 510. The wheel control module 505 is configured to communicate information regarding the motorized wheel assemblies 20, such as the rotary speed measured by the wheel speed sensor 515, to the CPU 72. Although only one wheel control module 505 is shown, each wheel assembly 20 can include a separate wheel control module 505 in communication with the CPU 72. In one embodiment, the wheel control module 505 can be integrated into the CPU 72 as a single processing unit. According to one example, the CPU 72 includes a single wheel control module 505 to control all four wheel assemblies 20. According to one example, the CPU 72 includes four wheel control modules 505, one for each wheel assembly 20.

The CPU 72 is configured to analyze the information received from the various components (e.g. cameras 40-43, proximity sensors 50, modules 61, 74, 75, 505, onboard UWB device 200, etc.) of the smart luggage system 100 and perform the computational functions programmed into the CPU 72 based on the information to operate the smart luggage system 100 as described herein. For example, the CPU 72 is configured to determine a given direction and speed based on the information (such as the position of the user as calculated by the onboard UWB device 200). In response, the CPU 72 is configured to control the direction and speed of the smart luggage system 100 relative to the user and/or the surrounding environment. Specifically, the CPU 72 is configured to control the direction and the speed of the smart luggage system 100 through the wheel control module 505 by instructing the wheel control module 505 to increase, decrease, or stop power, e.g. input current, supplied to each respective motorized wheel assembly 20.

Location of Onboard UWB Devices

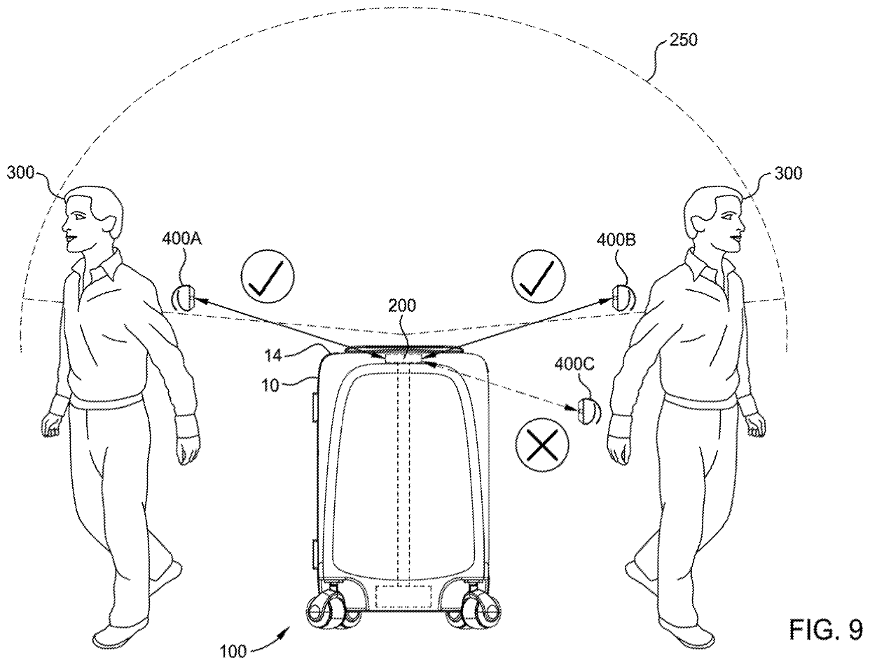

FIG. 9 is a schematic view of the smart luggage system 100 according to one embodiment. The onboard UWB device 200 is shown coupled to a top side 14 of the luggage 10. When located on the top of the luggage 10, the onboard UWB device 200 includes a target range 250 above the luggage 10. The onboard UWB device 200 can communicate with the personal user devices 400A, 4008 of the users 300 that are located within the target range 250. Each of the personal user devices 400A, 400B, 400C have mobile UWB devices 410 and transmitters 415 as described above. The onboard UWB device 200 may not be able to sense the personal user device 400C since it is not located within the target range 250. When located on the top of the luggage 10, the onboard UWB device 200 may not be able to communicate with any personal user device that is positioned at a location lower than the height of the luggage 10.

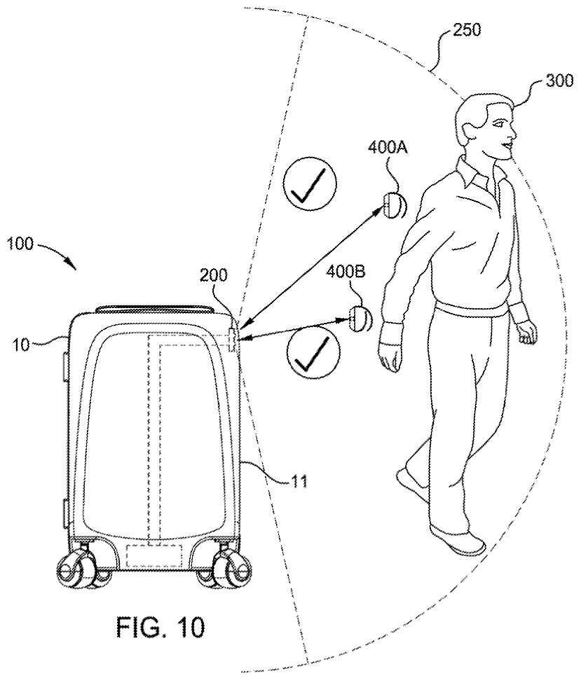

FIG. 10 is a schematic view of the smart luggage system 100 according to one embodiment. The onboard UWB device 200 is shown coupled to the front side 11 of the luggage 10. When located on the front side 11 of the luggage 10, the onboard UWB device 200 includes a target range 250 in front of the luggage 10. The onboard UWB device 200 can communicate with the personal user devices 400A, 400B of the user 300 that are located within the target range 250 in front of the luggage 10 at any height relative to the ground. Each of the personal user devices 400A, 400B have mobile UWB devices 410 and transmitters 415 as described above. The onboard UWB device 200 may not be able to sense any personal user devices that are not located within the target range 250. When located on the front side 11 of the luggage 10, the onboard UWB device 200 may not be able to communicate with any personal user device that is positioned behind the luggage 10.

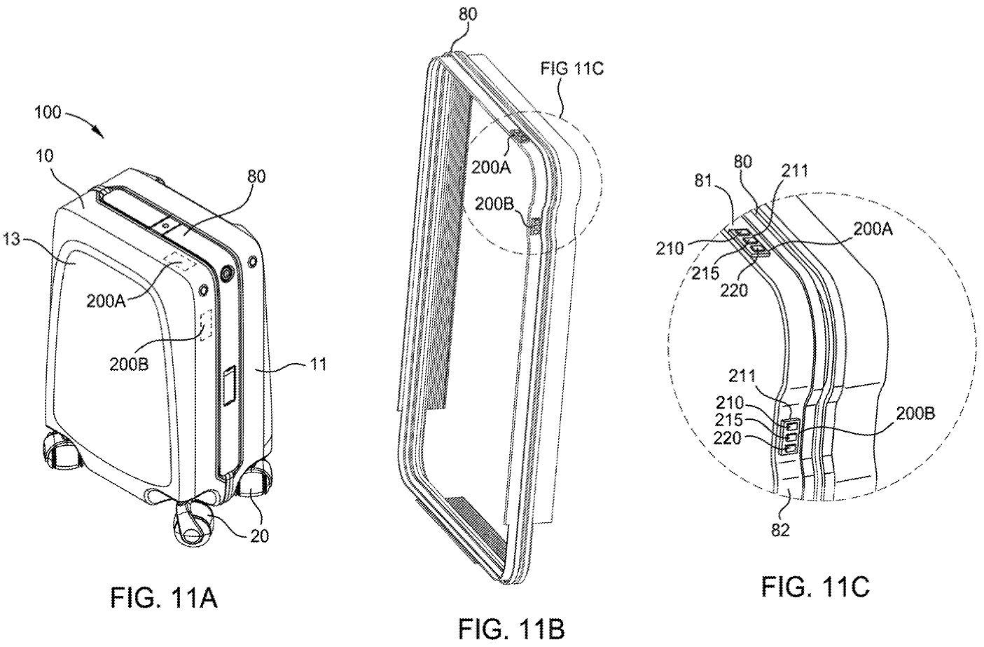

FIG. 11A is a schematic view of the smart luggage system 100 according to one embodiment. Two separate onboard UWB devices 200A, 220B are shown. The smart luggage system 100 may include only the onboard UWB device 200A, only the onboard UWB device 220B, or both UWB devices 200A, 200B. The UWB device 200A is shown located on the top end and closer to the left side 13 of the interior of the luggage 10 adjacent to a metallic frame 80 that is disposed about a center of the luggage 10. The UWB device 200B is shown located on the front side 11 and closer to the left side 13 of the interior of the luggage 10 adjacent to the metallic frame 80. The UWB devices 200A, 220B may be secured within a plastic housing that is coupled to the top edge/corner of the luggage 10 and oriented horizontally or vertically as shown. FIG. 11B is a schematic view of the metallic frame 80, which has a substantially rectangular shape and may be formed out of aluminum. FIG. 11C is an enlarged view of a portion of the metallic frame 80 and the location of two onboard UWB devices 200A, 200B that may be coupled to the luggage 10.

Referring to FIG. 11C, each onboard UWB device 200A, 200B includes the three transceivers 210, 215, 220 coupled to a printed circuit board 211. The onboard UWB device 200A is oriented horizontally and located adjacent to the metallic frame 80 on a support structure 81 that is coupled to the metallic frame 80 and/or forms part of the body of the luggage 10. The onboard UWB device 200B is oriented vertically and located adjacent to the metallic frame 80 on a support structure 82 that is coupled to the metallic frame 80 and/or forms part of the body of the luggage 10. The support structures 81, 82 may be the same or separate structures, and may be formed out a material including but not limited to acrylonitrile butadiene styrene, polypropylene, polycarbonate, fiber/carbon-fiber reinforced plastics, and the like. Although shown located on one side of the metallic frame 80, either one or both of the onboard UWB devices 200A, 200B may be located adjacent to any side of the metallic frame 80.

The onboard UWB devices 200A, 200B are located on the left side of the metallic frame 80 so that the metallic frame 80 does not block communication (e.g. signals such as radio frequency waves) to and from the onboard UWB devices 200A, 200B. As shown, the transceivers 210, 215, 220 are located to the side of the metallic frame 80 and are also located at a position that is higher than the top or outermost surface of the metallic frame 80. The height of the transceivers 210, 215, 220 is greater than the height of the aluminum frame 80. The transceivers 210, 215, 220 of the onboard UWB device 200A are located at a position move radially upward than the upper surface of the metallic frame 80. The transceivers 210, 215, 220 of the onboard UWB device 2008 are located at a position more laterally outward than the outer surface of the metallic frame 80. The transceivers 210, 215, 220 are located more radially upward and laterally outward relative to the metallic frame 80 so that any communication signals to and from the transceivers 210, 215, 220 are not blocked or otherwise obstructed by the metallic frame 80, resulting in better wireless communication.

While the foregoing is directed to embodiments of the disclosure, other and further embodiments of the disclosure thus may be devised without departing from the basic scope thereof, and the scope thereof is determined by the claims that follow.

1. A smart luggage system, comprising:
a piece of luggage configured to store items for transport;
an ultra-wideband (UWB) based tracking system configured to determine the position of a target relative to the luggage and comprising an onboard UWB device coupled to the luggage, wherein the onboard UWB device comprises three transceivers, a crystal oscillator, and a control module; and
a wheel control system configured to move the luggage in a given direction based on information from the UWB based tracking system, wherein the wheel control system comprises a plurality of motorized wheel assemblies coupled to the luggage.

2. The system of claim 1, further comprising a computer based tracking system configured to determine the position of the target relative to the luggage, the computer based tracking system comprising a camera for target recognition, a camera having an optical filter, and a laser emitter each coupled to the luggage.

3. The system of claim 2, further comprising a personal user device having a mobile UWB device with a transmitter configured to transmit a signal to the three transceivers.

4. The system of claim 3, wherein the personal user device is a cellular phone or a wristband.

5. The system of claim 2, further comprising a central processing unit configured to receive the information from the UWB based tracking system and the computer based tracking system, and in response instruct the wheel control system to move the luggage in the given direction to follow the target in a rear following position or a side following position.

6. The system of claim 1, wherein the control module of the onboard UWB device is configured to determine an angle of arrival of a signal as received by the transceivers to determine a position angle of the target relative to two of the three transceivers, and then determine the proximity of the target relative to the luggage based on the two transceivers having the largest position angle.

7. The system of claim 6, wherein the control module of the onboard UWB device is configured to determine a time difference of arrival of a signal as received by the three transceivers, and then determine a side on which the target is located relative to the luggage based on the transceiver that first received the signal.

8. The system of claim 7, wherein each transceiver is coupled to the crystal oscillator and have the same clock signal to determine the time difference of arrival of the signal as received by the three transceivers.

9. The system of claim 1, wherein the UWB device is coupled to a top side of the luggage.

10. The system of claim 2, wherein the computer based tracking system is coupled to a handle of the luggage.

11. The system of claim 1, wherein the wheel control system is coupled to a bottom end of the luggage.

12. A smart luggage system, comprising:
a piece of luggage configured to store items for transport;
an ultra-wideband (UWB) based tracking system configured to determine the position of a target relative to the luggage and comprising an onboard UWB device coupled to the luggage, wherein the onboard UWB device comprises three transceivers, a crystal oscillator, and a control module;
an obstacle avoidance system configured to determine the position of an obstacle relative to the luggage and comprising a camera for environment recognition, a camera having an optical filter, a laser emitter, and a proximity sensor each coupled to the luggage; and
a wheel control system configured to move the luggage in a given direction based on information from the UWB based tracking system and the obstacle avoidance system, wherein the wheel control system comprises a plurality of motorized wheel assemblies coupled to the luggage.

13. The system of claim 12, further comprising a personal user device having a mobile UWB device with a transmitter configured to transmit a signal to the three transceivers.

14. The system of claim 13, wherein the personal user device is a cellular phone or a wristband.

15. The system of claim 12, further comprising a central processing unit configured to receive the information from the UWB based tracking system and the obstacle avoidance system, and in response instruct the wheel control system to move the luggage in the given direction to follow the target in a rear following position or a side following position.

16. The system of claim 12, wherein the control module of the onboard UWB device is configured to determine an angle of arrival of a signal as received by the transceivers to determine a position angle of the target relative to two of the three transceivers, and then determine the proximity of the target relative to the luggage based on the two transceivers having the largest position angle.

17. The system of claim 16, wherein the control module of the onboard UWB device is configured to determine a time difference of arrival of a signal as received by the three transceivers, and then determine a side on which the target is located relative to the luggage based on the transceiver that first received the signal.

18. The system of claim 17, wherein each transceiver is coupled to the crystal oscillator and have the same clock signal to determine the time difference of arrival of the signal as received by the three transceivers.

19. The system of claim 12, wherein the UWB device is coupled to a top end of the luggage.

20. The system of claim 12, wherein the camera for environment recognition, the camera having the optical filter, and the laser emitter of the obstacle avoidance system are coupled to a handle of the luggage.

21. The system of claim 12, wherein the wheel control system is coupled to a bottom end of the luggage.

22. A method of tracking a target using a smart luggage system, comprising:
receiving a signal from a mobile ultra-wideband (UWB) device of a personal user device of a target;
determining a position of the target relative to a piece of luggage based on the signal using a UWB based tracking system having an onboard UWB device coupled to the luggage, wherein the onboard UWB device comprises three transceivers, a crystal oscillator, and a control module;
determining a position of the target relative to the luggage using a computer based tracking system having a camera for target recognition, a camera having an optical filter, and a laser emitter each coupled to the luggage; and
moving the luggage in a given direction based on the position of the target as determined by the UWB based tracking system and the computer based tracking system.

23. The method of claim 22, wherein determining the position of the target using the UWB based tracking system comprises:
determining an angle of arrival of the signal as received by the transceivers to determine a position angle of the target relative to two of the three transceivers; and
determining the proximity of the target relative to the luggage based on the two transceivers having the largest position angle.

24. The method of claim 23, wherein determining the position of the target using the UWB based tracking system further comprises:
determining a time difference of arrival of the signal as received by the three transceivers; and
determining a side on which the target is located relative to the luggage based on the transceiver that first received the signal.

25. The method of claim 24, wherein determining the position of the target using the computer vision based tracking system comprises:
identifying the target using the camera for target recognition;
determining the proximity of the target relative to the luggage using the camera having the optical filter and the laser emitter; and
determining the position of the target relative to the luggage based on the identity and proximity of the target.

26. The method of claim 25, further comprising receiving information from the UWB based tracking system and the computer based tracking system regarding the position of the target relative to the luggage, and in response instructing a wheel control system to move the luggage in the given direction to follow the target in a rear following position or a side following position.

27. The method of claim 26, wherein the personal user device is a cellular phone or a wristband.

28. A method of tracking a target using a smart luggage system, comprising:
receiving a signal from a mobile ultra-wideband (UWB) device of a personal user device of a target;
determining a position of the target relative to a piece of luggage based on the signal using a UWB based tracking system having an onboard UWB device coupled to the luggage, wherein the onboard UWB device comprises three transceivers, a crystal oscillator, and a control module;
determining a position of an obstacle relative to the luggage using an obstacle avoidance system having a camera for environment recognition, a camera having an optical filter, a laser emitter, and a proximity sensor each coupled to the luggage; and
moving the luggage in a given direction to avoid the obstacle based on the position of the target as determined by the UWB based tracking system and the position of the obstacle as determined by the obstacle avoidance system.

29. The method of claim 28, wherein determining the position of the target using the UWB based tracking system comprises:
determining an angle of arrival of the signal as received by the transceivers to determine a position angle of the target relative to two of the three transceivers; and
determining the proximity of the target relative to the luggage based on the two transceivers having the largest position angle.

30. The method of claim 29, wherein determining the position of the target using the UWB based tracking system further comprises:
determining a time difference of arrival of the signal as received by the three transceivers; and
determining a side on which the target is located relative to the luggage based on the transceiver that first received the signal.

31. The method of claim 30, wherein determining the position of the obstacle using the obstacle avoidance system comprises:
identifying the obstacle using the camera for environment recognition;
determining the proximity of the obstacle relative to the luggage using the camera having the optical filter, the laser emitter, and the proximity sensor; and
determining the position of the obstacle relative to the luggage based on the identity and proximity of the obstacle.

32. The method of claim 31, further comprising receiving information from the UWB based tracking system and the obstacle avoidance system regarding the position of the target relative to the luggage and the position of the obstacle relative to the luggage, and in response instructing a wheel control system to move the luggage in the given direction to follow the target in a rear following position or a side following position while avoiding the obstacle.

33. The method of claim 32, wherein the personal user device is a cellular phone or a wristband.
